(19) United States
(12) Patent Application Publication
(10) Pub. No.: US 2026/0228916 A1
(43) Pub. Date: Aug. 6, 2026

(54) OUTPUTTING VISUAL CONTENT CONSIDERING SMARTGLASSES FRAME DEFORMATION

(71) Applicant: GOOGLE LLC, Mountain View, CA (US)

(72) Inventors: Joshua Anthony Hernandez, Redwood City, CA (US); Zhiheng Jia, Sunnyvale, CA (US); Ryan Christopher DuToit, Redwood City, CA (US); Mingsong Dou, Cupertino, CA (US); Chao Guo, Los Altos, CA (US)

(21) Appl. No.: 19/150,380

(22) PCT Filed: Feb. 21, 2023
(86) PCT No.: PCT/US2023/062941

§ 371 Date: Jul. 23, 2025

(51) Int. Cl. G06T 7/80

(52) U.S. Cl. CPC G06T 7/80

(57) ABSTRACT

Techniques of maintaining user comfort while using augmented reality smartglasses include performing an online calibration of frame deformation to correct display position in the lens. Such a calibration involves modeling the frame portion between the world-facing camera and the eye-tracking camera as a hinge that rotates about an axis on and normal to the frame portion. That is, the frame portion consists of two line segments that are joined at an axis at an unknown rotation (angle) to be determined.

### BACKGROUND

Eyewear in the form of glasses may be worn by a user to, for example, provide for vision correction, inhibit sun/glare, provide a measure of safety, and the like. These types of eyewear are typically somewhat flexible and/or deformable, so that the eyewear can be manipulated to comfortably fit the user. An ophthalmic technician can typically manipulate rim portions and/or temple arm portions of a frame of the eyewear, for example, through cold working the frame and/or heating and re-working the frame, to adjust the eyewear for a particular user. In some situations, this re-working of the frame may occur over time, through continued use/wearing of the eyewear by the user. Manipulation in this manner, due to the flexible and/or deformable nature of the material of the frame and/or lenses of the eyewear, may provide a comfortable fit while still maintaining ophthalmic alignment between the eyewear and the user. In a situation in which the eyewear is a head mounted computing device including a display, such as, for example, smartglasses, this type of flexibility/deformation in the frame may cause inconsistent alignment for the display, or misalignment of the display. Inconsistent alignment, or misalignment of the display can cause visual discomfort, particularly in the case of a binocular display.

### SUMMARY

Implementations described herein are related to online calibration of frame deformations in smartglasses. Specifically, while a flexible frame provides a level of comfort to a smartglasses user, the frame deformations that result may cause a measure of discomfort due to misalignment of cameras disposed on the smartglasses frame and the display projected onto the lens. For example, the relative orientation of the world-facing camera with respect to the eye-tracking camera on the frame is subject to perturbations when the frame is flexed. Moreover, this relative orientation may also change subject to temperature, frame age, and sudden shocks, e.g., dropping the smartglasses. Nevertheless, it has been determined that if a frame portion between the world-facing camera and the eye-tracking camera is modeled as a hinge that rotates about an axis normal to a point on the frame portion, then the hinge rotation may be determined via measurements from projections of illuminated points on an object in each of the world-facing camera and the eye-tracking camera. Once the hinge rotation is determined by a controller, the controller may then correct the location of the display on the smartglasses lens and maintain comfort for the user.

In one general aspect, a method can include generating projection data representing a projection of a point on an object in both a world-facing camera and an eye-tracking camera, the world-facing camera and the eye-tracking camera being mounted on a frame of a smartglasses device. The method can also include calculating a hinge angle about a hinge center between the world-facing camera and the eye-tracking camera based on the projection data, the hinge angle indicating a level of deformation of the frame of the smartglasses device. The method can further include determining a position of visual content output by a display within a lens of the smartglasses device based on the hinge angle.

In another general aspect, a computer program product comprises a non-transitory storage medium, the computer program product including code that, when executed by processing circuitry, causes the processing circuitry to perform a method. The method can include generating projection data representing a projection of a point on an object in both a world-facing camera and an eye-tracking camera, the world-facing camera and the eye-tracking camera being mounted on a frame of a smartglasses device. The method can also include calculating a hinge angle about a hinge center between the world-facing camera and the eye-tracking camera based on the projection data, the hinge angle indicating a level of deformation of the frame of the smartglasses device. The method can further include determining a position of visual content output by a display within a lens of the smartglasses device based on the hinge angle.

In another general aspect, an apparatus comprises memory, and processing circuitry coupled to the memory. The processing circuitry can be configured to generate projection data representing a projection of a point on an object in both a world-facing camera and an eye-tracking camera, the world-facing camera and the eye-tracking camera being mounted on a frame of a smartglasses device. The processing circuitry can also be configured to calculate a hinge angle about a hinge center between the world-facing camera and the eye-tracking camera based on the projection data, the hinge angle indicating a level of deformation of the frame of the smartglasses device. The processing circuitry can further be configured to determine a position of visual content output by a display within a lens of the smartglasses device based on the hinge angle.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example head mounted wearable device worn by a user.

FIG. 1B is a front view, and FIG. 1C is a rear view of the example head mounted wearable device shown in FIG. 1A.

FIG. 2A is a diagram illustrating an example orientation between a world-facing camera and an eye-tracking camera on a smartglasses frame.

FIG. 2B is a diagram illustrating an example, simplified hinge model of the frame deformation of the frame portion between the world-facing camera and the eye-tracking camera.

FIG. 2C is a diagram illustrating the example, simplified hinge model for the case of an unobservable hinge angle.

FIG. 3 is a diagram illustrating an example apparatus for performing the online calibration per the improved techniques described herein.

FIG. 4 is a flow chart illustrating an example method for performing the online calibration per the improved techniques described herein.

### DETAILED DESCRIPTION

This disclosure relates to the wearing and use of smartglasses and maintaining a degree of user comfort during use of the smartglasses. A technical problem with smartglasses is that the maintenance of comfort for the user is difficult to achieve. Maintaining a degree of comfort, on the one hand, indicates that the frame of the smartglasses be flexible. On the other hand, maintaining a degree of comfort indicates that the display be projected where the user is looking. Because the determination of where the user is looking is achieved via an eye-tracking camera disposed on the frame, a flexible frame may induce deformations that deflect the orientation of the eye-tracking camera enough to misalign the display from the user's gaze direction.

In accordance with the implementations described herein, a technical solution to the above-described technical problem includes performing an online calibration of frame deformation to correct display position in the lens. Such a calibration involves modeling the frame portion between the world-facing camera and the eye-tracking camera as a hinge that rotates about an axis on the frame portion. That is, the frame portion can be modeled as two rigid arms that are joined at a hinge center along a hinge axis at an unknown hinge angle about the hinge center to be determined. The world-facing camera is at an end of one arm and the eye-tracking camera is at the end of the other arm. In this treatment, any translation induced will be neglected.

Online calibration refers to a calibration of the smartglasses display output with respect to sensor extrinsics in real time while the smartglasses are being worn. Sensor extrinsics include their relative orientation and their orientation with respect to the display. Extrinsic errors between the world-facing camera and the eye-tracking camera can have a great impact on the display output alignment. A display misalignment-especially a vertical misalignment-could in turn impact user interface alignment accuracy for, e.g., navigation applications. Accordingly, it is advantageous to be able to detect and correct errors in the sensor extrinsics while the smartglasses are worn in real time, i.e., online.

The hinge angle, then, may be used as an indicator of the sensor exstrinsics and, ultimately, a level of deformation of the frame of the smartglasses. Because the hinge angle is a quantity that has only one degree of freedom, it may be computed in real time and therefore may be part of an online calibration scheme. That said, the hinge model defining the hinge angle is an approximation of reality and does not represent an approach to a precise determination of smartglasses sensor extrinsics. Rather, the hinge angle is a useful approximation that serves as a real-time guide as to how the display should be configured at any given instant of time.

For example, an example smartglasses frame that is not worn and unflexed (e.g., not deformed) may have a nominal hinge angle of 90 degrees. That is, in this example, a hinge angle of 90 degrees implies that the display output is in a location where the user expects. When the user wears the glasses and flexes the frame, the hinge angle is determined to change away from 90 degrees. At this angle away from the nominal angle of 90 degrees, the sensor extrinsics have changed and the display output becomes misaligned. Nevertheless, knowing that the hinge angle is some angle other than 90 degrees provides information to a processor in the smartglasses to move the visual content output by the display by a corresponding amount.

Accordingly, the technical solution to the technical problem involves a rapid, real-time determination of the misalignment of a smartglasses display based on the projection image of a single point on an object as imaged by both the world-facing camera and the eye-tracking camera.

It is noted that the determination of the misalignment of the smartglasses display is made based on a feature extraction process. Processing circuitry on the smartglasses generates projection data that represents, e.g., includes coordinate values of a projection of a point of an object in both the world-facing camera and the eye-tracking camera. Such a projection of the point of the object in the world-facing camera includes camera coordinates of the point in the local world-facing camera coordinate system. Such a projection of the point of the object in the eye-tracking camera includes camera coordinates of the point in the local eye-tracking camera coordinate system. The feature extraction process includes identifying the point as imaged in both cameras based on common statistics and determining the coordinates of the point in either camera coordinate system.

The processing circuitry on the smartglasses also calculates a hinge angle that indicates a level of deformation of the frame of the smartglasses. In this context, generating may include computing (calculating) the hinge angle based on (e.g., using) the projection data, e.g., the coordinates of the projection of the point in both cameras. The computation of the hinge angle is performed on the basis of the above-described hinge model, which considers the cameras as virtual endpoints of straight lines connected at the hinge center and which rotate with respect to each other along a hinge axis.

Accordingly, the hinge angle is an angle between two line segments, each with a camera at its endpoint, with the line segments meeting at the hinge angle at the hinge center. The processing circuitry calculates a hinge angle by solving a trigonometric equation for the hinge angle: a+b cos θ+c sin θ=0, wherein θ is the hinge angle and a, b, and c are specified parameters. The specified parameters are combinations of, e.g., the location of the hinge center, the direction of the hinge axis, the coordinates of the projection of the point in either camera, and the lengths of the hinge arms.

In some implementations, the hinge angle is determined via a projection of a point of an object in the world-facing camera and the eye-tracking camera. For example, the point-common to the fields of view of both the world-facing camera and the eye-tracking camera-is determined in the coordinate systems of the world-facing camera and the eye-tracking camera using the above-described feature extraction process. Because the hinge models have hinge arms that are rigid, the coordinate system of the eye-tracking camera can be expressed in terms of the coordinate system of the world-facing camera via a coordinate transformation.

From the coordinate transformation between the world-facing camera and the eye-tracking camera and the epipolar constraint, one may derive an equation for the hinge angle in terms of the location of the hinge center, the hinge axis direction, and projections of the point of the object in the world-facing camera and the eye-tracking camera.

In some implementations, the hinge angle may be determined to be unobservable based on a relationship between the point of the object, the world-facing camera, the eye-tracking camera, and the hinge center. That is, when the hinge angle is unobservable, the configuration of the point, the world-facing camera, the eye-tracking camera, and the hinge center is such that the same measurement (i.e., projection of the point in the cameras) can produce a range of possible hinge angle values, e.g., there is no unique hinge angle value for a given measurement, e.g., the hinge angle is unobservable. In some implementations, the hinge angle may be determined to be unobservable based on whether the point of the object is situated such that the projection of the point in the world-facing camera is situated along a line of sight of the world-facing camera.

The processing circuitry on the smartglasses may also be configured to determine a position of visual content output by the smartglasses display within a lens of the smartglasses based on the hinge angle. For example, the processing circuitry may define a baseline hinge angle which indicates no deformation of the frame. A hinge angle that deviates from the baseline hinge angle indicates a misalignment of the visual content output by the display relative to an expected position. In some implementations, the position of the visual content is determined from the hinge angle based on a machine learning engine. In some implementations, the position of the visual content is determined from the hinge angle based on a lookup table.

A technical advantage of the technical solution is that the model is deterministic and can be evaluated from a single point on an object. Such an accurate determination of the hinge rotation translates into accurate placement of the visual content output by a display within a flexible frame and comfort for the user.

In some implementations, the projection data is generated via a feature extraction and matching process in the world-facing camera and the eye-tracking camera.

In some implementations, generating the hinge angle includes determining whether the hinge rotation is observable.

In some implementations, the hinge angle is observable if the point is noncoplanar with a plane defined by the world-facing camera, the eye-tracking camera, and the hinge center.

In some implementations, the hinge angle is not observable if the projection of the point in the world-facing camera is situated along a line of sight of the world-facing camera.

In some implementations, generating the hinge angle includes generating a solution to an equation, the equation being a+b cos θ+c sin θ=0, wherein θ is the hinge rotation and a, b, and c are specified parameters.

In some implementations, solving the equation includes determining whether a spurious value of θ satisfies the equation.

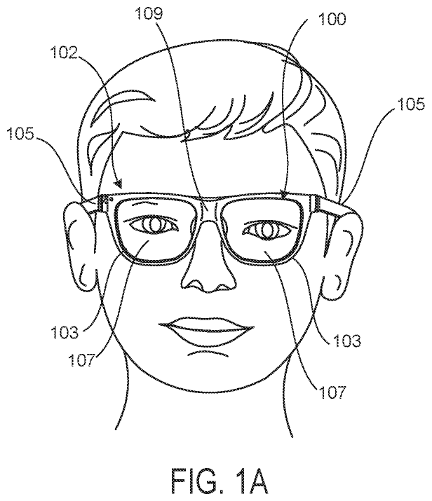

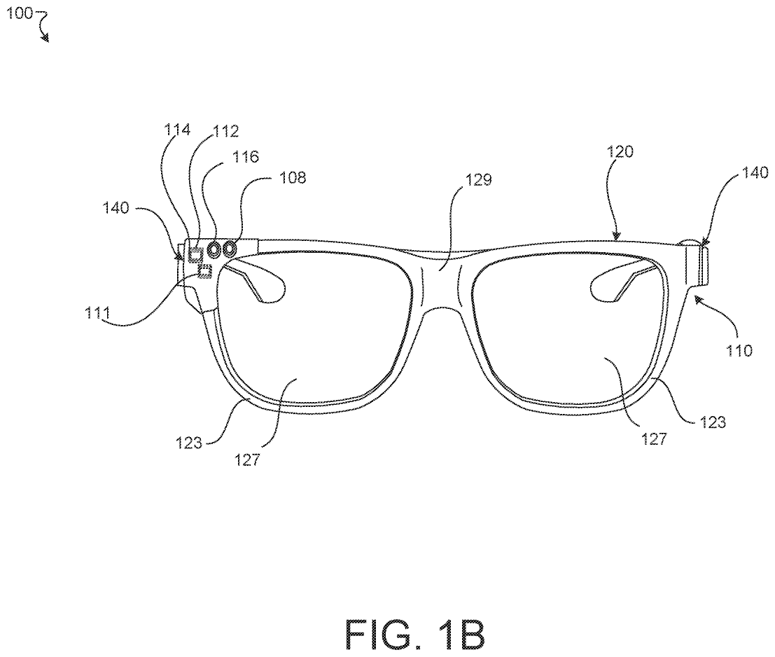

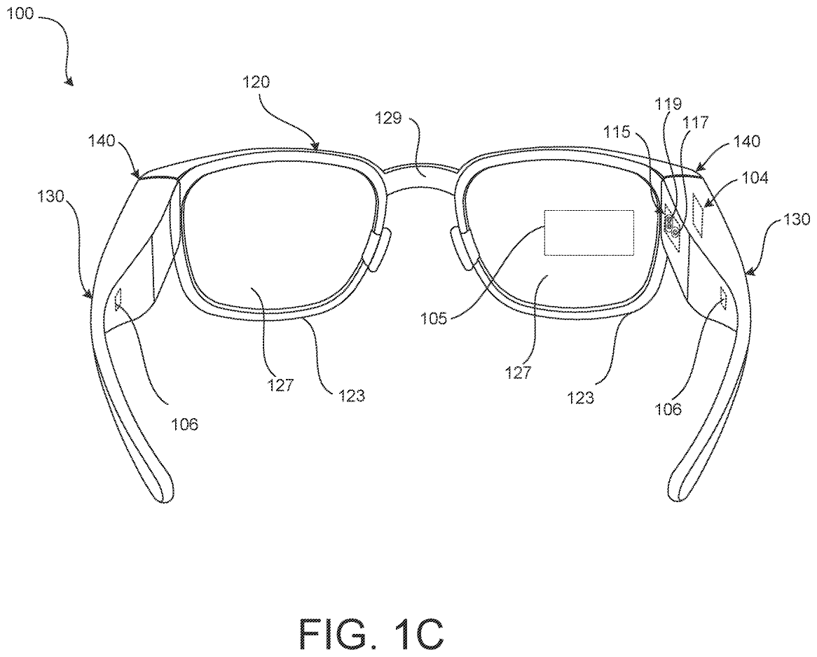

FIG. 1A illustrates a user wearing an example head mounted wearable device 100 in the form of smart glasses, or augmented reality glasses, including display capability, eye/gaze tracking capability, and computing/processing capability. FIG. 1B is a front view, and FIG. 1C is a rear view, of the example head mounted wearable device 100 shown in FIG. 1A. The example head mounted wearable device 100 includes a frame 110. The frame 110 includes a front frame portion 120, and a pair of temple arm portions 130 rotatably coupled to the front frame portion 120 by respective hinge portions 140. The front frame portion 120 includes rim portions 123 surrounding respective optical portions in the form of lenses 127, with a bridge portion 129 connecting the rim portions 123. The temple arm portions 130 are coupled, for example, pivotably or rotatably coupled, to the front frame portion 120 at peripheral portions of the respective rim portions 123. In some examples, the lenses 127 are corrective/prescription lenses. In some examples, the lenses 127 are an optical material including glass and/or plastic portions that do not necessarily incorporate corrective/prescription parameters.

In some examples, the wearable device 100 includes a display device 104 that can output visual content, for example, at an output coupler 105, so that the visual content is visible to a user (not shown in FIGS. 1B and 1C). In the example shown in FIGS. 1B and 1C, the display device 104 is provided in one of the two arm portions 130, simply for purposes of discussion and illustration. Display devices 104 may be provided in each of the two arm portions 130 to provide for binocular output of content. In some examples, the display device 104 may be a see through near eye display. In some examples, the display device 104 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 127, next to content (for example, digital images, user interface elements, virtual content, and the like) output by the display device 104. In some implementations, waveguide optics may be used to depict content on the display device 104.

In some examples, the head mounted wearable device 100 includes one or more of an audio output device 106 (such as, for example, one or more speakers), an illumination device 108, a sensing system 111, a control system 112, at least one processor 114, and an outward facing image sensor 116, or camera 116. In some examples, the sensing system 111 may include various sensing devices and the control system 112 may include various control system devices including, for example, one or more processors 114 operably coupled to the components of the control system 112. In some examples, the control system 112 may include a communication module providing for communication and exchange of information between the wearable computing device 100 and other external devices. In some examples, the head mounted wearable device 100 includes a gaze tracking device 115 to detect and track eye gaze direction and movement. Data captured by the gaze tracking device 115 may be processed to detect and track gaze direction and movement as a user input. In the example shown in FIGS. 1B and 1C, the gaze tracking device 115 is provided in one of the two arm portions 130, simply for purposes of discussion and illustration. In the example arrangement shown in FIGS. 1B and 1C, the eye tracking device 115 is provided in the same arm portion 130 as the display device 104, so that user eye gaze can be tracked not only with respect to objects in the physical environment, but also with respect to the content output for display by the display device 104. In some examples, gaze, or eye-tracking devices 115 may be provided in each of the two arm portions 130 to provide for gaze tracking of each of the two eyes of the user. In some examples, display devices 104 may be provided in each of the two arm portions 130 to provide for binocular display of visual content.

It is noted that the one or more processors 114 may be part of processing circuitry used to generate the projection data and then generate the hinge angle using the projection data.

In some situations, the frame 110 of the head mounted wearable device 100 may experience deflection, or deformation. This may occur due to, for example, a head size and/or shape of the user wearing the head mounted wearable device 100, movement or slippage of the head mounted wearable device 100, and other such factors. For example, a frame having rigid/non-flexible components, while still providing some level of flexibility in certain portions of the frame, may maintain alignment of the display, and may be effective in housing electronic components of such a head mounted computing device including a display. Deformation or deflection or slippage that causes, for example, a relative shift in position and/or orientation between the image sensor 117 and the lens 127 may affect the accuracy of eye/gaze tracking performed based on the images captured by the image sensor 117 of the eye-tracking device 115. Similarly, deformation or deflection or slippage that causes a relative shift in position and/or orientation between one or both of the arm portion(s) 130 in which the display device(s) 104 is/are provided and the front frame portion 120 of the frame 110 may the user's ability to view visual content output by the display device 104.

Accordingly, when the frame 110 is modeled as a hinge as described above, a hinge angle that deviates from a nominal value corresponds to a change in position and/or orientation to visual content output by the display device 104. In an example, one arm of the hinge model can correspond to the front frame portion 120, the other arm can correspond to a temple arm portion 130, and the hinge center can correspond to the hinge portion 140. Determination of the hinge angle thus enables determination of a position of the visual content output by the display device 104. The determination of the position of the visual content output by the display device 104 then allows for a correction to the position such that a user is able to view the content as if the frame were not deformed.

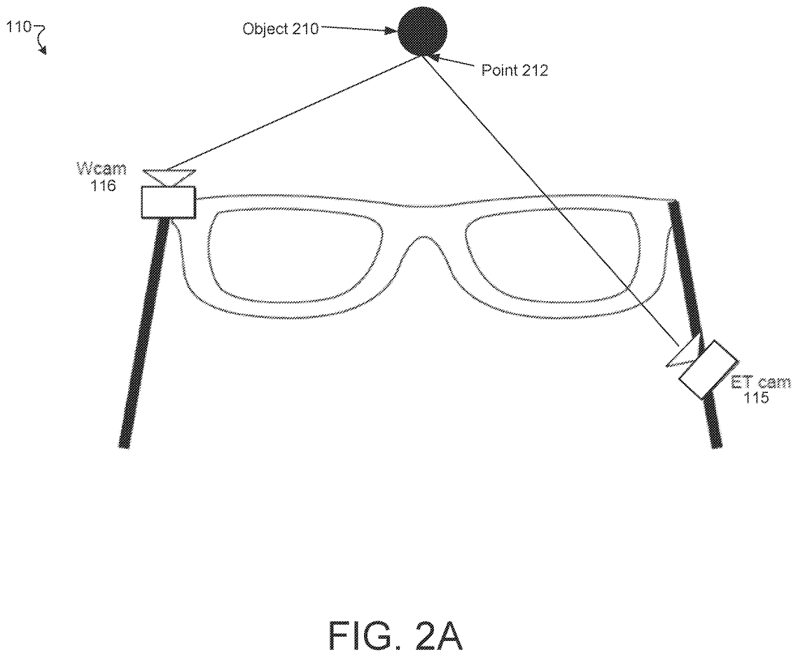

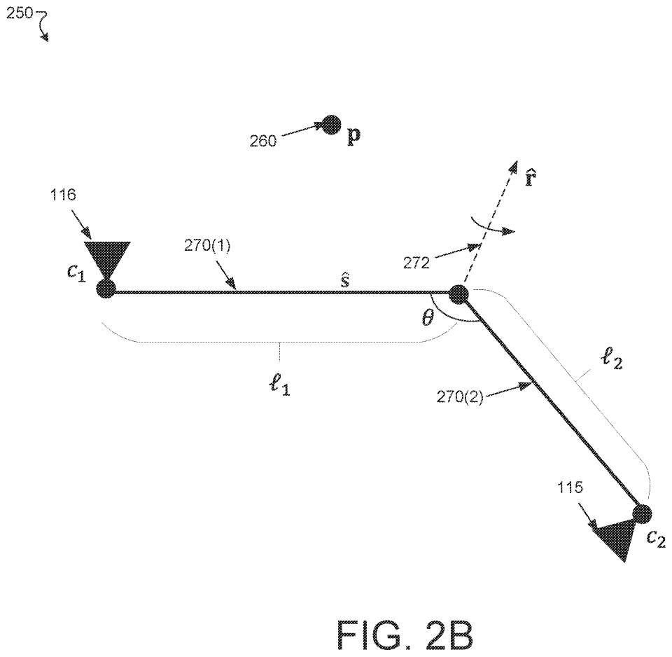

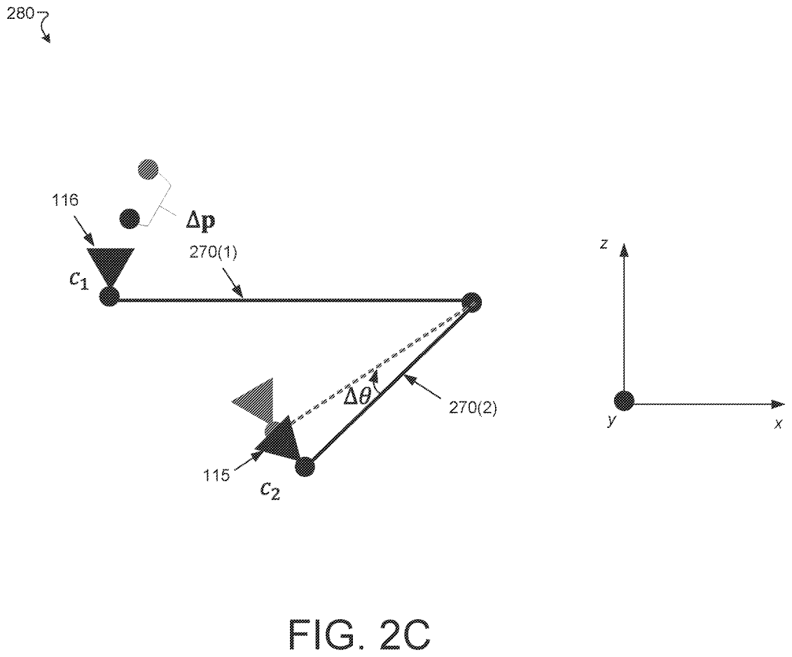

FIG. 2A is a diagram illustrating an example orientation between a world-facing camera 116 and an eye-tracking camera 115 on a smartglasses frame 110. If the smartglasses frame 110 were rigid, the world-facing camera 116 and the eye-tracking camera 115 would be in a fixed relative orientation. In such a scenario, the eye-tracking camera 115 would remain at a fixed orientation with respect to the eye of the user and would thereby be able to cause the display to be projected to the location in the lens at which the user is gazing.

Nevertheless, because the frame 110 is flexible, the world-facing camera 116 and the eye-tracking camera 115 are not in a fixed relative orientation due to frame deformations. Moreover, the frame deformation may also cause a change in position/orientation of the lenses and accordingly the display position may be changed even further.

As shown in FIG. 2A, each of the world-facing camera 116 and eye-tracking camera 115 has a view of a point 212 of an object 510. The world-facing camera 116 has a view of the point 212 from a first camera angle; the eye-tracking camera 115 has a view of the point 212 from a second camera angle. The first camera angle determines a projection of the point 212 in the world-facing camera 116; the second camera angle determines a projection of the point 212 in the eye-tracking camera.

FIG. 2B is a diagram illustrating an example, simplified hinge model of the frame deformation of the frame portion 250 between the world-facing camera 116 and the eye-tracking camera 115. In FIG. 2B, the world-facing camera 116 is denoted as c₁ and the eye-tracking camera 115 is denoted as c₂. As shown in FIG. 2B, the simplified hinge model includes a first hinge arm 270(1) of length [symbol] and a second hinge arm 270(2) of length [symbol] both originating at a hinge center s. The hinge arm 270(1) is terminated at a first virtual point representing the world-facing camera 116 and the hinge arm 270(2) is terminated at second virtual point representing the eye-tracking camera 115.

As shown in FIG. 2B, the simplified hinge model includes an axis 272 in the direction denoted as \hat{r}. The point 260 on an object (not shown) and visible to both cameras c₁ and c₂ is denoted as p. Given the two-dimensional projections of p in the two cameras, the goal is to estimate the unknown hinge angle θ.

The coordinate transformation between the two cameras c₁ and c₂ be (R, t). Assume, without loss of generality, that R=I₃ (the identity matrix in three dimensions) when θ=0. Let s be the hinge center, such that both \hat{r} and s are expressed in the coordinates of c₁, e.g., in a coordinate system with the camera c₁ as the origin. Then

$$R = exp ( {θ [ \hat{r} ]}_{\times } ) and t = s - ( \frac{{ℓ}_{2}}{{ℓ}_{1}} ) Rs .$$

Let ₁p and ₂p be the coordinates of p relative to the cameras c₁ and c₂, respectively. Then

$${}_{2} p = {R}^{T} {(}_{1} p - s ) + ( \frac{{ℓ}_{2}}{{ℓ}_{1}} ) s . \qquad ( 1 )$$

Also, let

$${}_{1} x = [ \begin{matrix}{}_{1} {p}_{1} / {}_{1} {p}_{3} \\ {}_{1} {p}_{2} / {}_{1} {p}_{3}\end{matrix} ] and {}_{2} x = [ \begin{matrix}{}_{2} {p}_{1} / {}_{2} {p}_{3} \\ {}_{2} {p}_{2} / {}_{2} {p}_{3}\end{matrix} ]$$

be the projections of p in the cameras c₁ and c₂, respectively.

Before proceeding to determine an estimate of the hinge angle θ, the observability conditions by which 0 may be uniquely estimated are determined. To analyze the observability of θ, one stacks gradients of the projections of p in the cameras c₁ and c₂.

$$g = [ \begin{matrix}\partial {}_{1} x / \partial {}_{1} p & \partial {}_{1} x / \partial θ \\ \partial {}_{2} x / \partial {}_{1} p & \partial {}_{2} x / \partial θ\end{matrix} ] = [ \begin{matrix}{P}_{1} & {0}_{2 \times 1} \\ {P}_{2} {R}^{T} & {P}_{2} ( \partial {R}^{T} / \partial θ ) {(}_{1} p - s )\end{matrix} ] ,$$

where

$$\frac{\partial {R}^{T}}{\partial θ} = - {{R}^{T} [ \hat{r} ]}_{\times }$$

$$and$$

$${P}_{i} = \partial {}_{i} x / \partial {}_{i} p = [ \begin{matrix}1 / {}_{i} {p}_{3} & 0 & - {}_{i} {p}_{1} / {}_{i} {p}_{3}^{2} \\ 0 & 1 / {}_{i} {p}_{3} & - {}_{i} {p}_{2} / {}_{i} {p}_{3}^{2}\end{matrix} ] ,$$

where i∈{1,2}. It is noted that Pᵢ has rank 2 and its nullspace is spanned by ᵢp.

If a vector [δ₁p, δθ]^{T} lies in the nullspace of g, then

$${P}_{1} δ {}_{1} p = 0 and {P}_{2} {R}^{T} ( δ {}_{1} p - \hat{r} \times ( {}_{1} p - s ) δθ ) = 0 .$$

This implies that

$$δ {}_{1} p ‖ {}_{1} p \qquad ( 2 )$$

$$and$$

$${δ}_{1} p - \hat{r} \times ( {}_{1} p - s ) δθ ‖ R {}_{2} p \qquad ( 3 )$$

Combining (1), (2), and (3), it becomes apparent that there exist scalars α and β such that

$$α {}_{1} p + β \hat{r} \times ( {}_{1} p - s ) = {}_{1} p - t .$$

This last condition is equivalent to the condition that the hinge angle θ is unobservable when the cameras c₁ and c₂ and the hinge center are coplanar with the point p. That is, the hinge angle θ is observable (i.e., there exists a unique estimate) when p is noncoplanar with the plane defined by the world-facing camera, the eye-tracking camera, and the hinge center.

FIG. 2C is a diagram illustrating the example, simplified hinge model for the case 280 of an unobservable hinge angle. In this case, both cameras c₁ and c₂ lie in the x-z plane and the rotation axis points along the y axis. Accordingly, a pair of measurements ₁x and ₂x is consistent with a wide range of hinge angles θ, corresponding to a range of points p. As illustrated in FIG. 2C, the hinge angle θ is unobservable when if the projection of the point in the world-facing camera is situated along a line of sight of the world-facing camera.

When θ is observable, the epipolar constraint may be used to determine a unique solution for θ. Let ₁y=₁p/₁p₃ and ₂y=₂p/₂p₃ be the projections of ₁p and ₂p into the plane z=1, respectively. The epipolar constraint between ₁p and ₂p can be expressed in terms of ₁y and ₂y as follows.

$$0 = {}_{1} y \cdot ( t \times {R}_{2} y ) = {}_{1} y \cdot ( {ℓ}_{1} \hat{s} \times {R}_{2} y \cdot - {ℓ}_{2} R ( \hat{s} \times {R}_{2} y ) ) .$$

Applying Rodrigues' rotation formula, the following equation for the hinge angle is obtained.

$$a + b cos θ + c sin θ = 0 \qquad ( 4 )$$

where

$$a = {}_{1} y \cdot ( {ℓ}_{1} \hat{s} \times ( \hat{r} \cdot {}_{2} y ) \hat{r} - {ℓ}_{2} ( \hat{r} \cdot ( \hat{s} \times {}_{2} y ) ) \hat{r} ) ,$$

$$b = {}_{1} y \cdot ( \hat{r} \times ( \hat{r} \times ( \hat{s} \times {}_{2} y ) ) - \hat{r} \times ( \hat{r} \times {}_{2} y ) ) ,$$

$$c = {}_{1} y \cdot ( \hat{r} \times {}_{2} y - \hat{r} \times ( \hat{s} \times {}_{2} y ) ) .$$

That is, in Eq. (4) a, b, and c are specified parameters which may uniquely determine the hinge angle θ. However, there may be two solutions to Eq. (4), wherein one of the solutions is the (correct) hinge angle while the other solution is spurious. The spurious solution corresponds to a value of θ in which there is no projection of the point in the camera c₂.

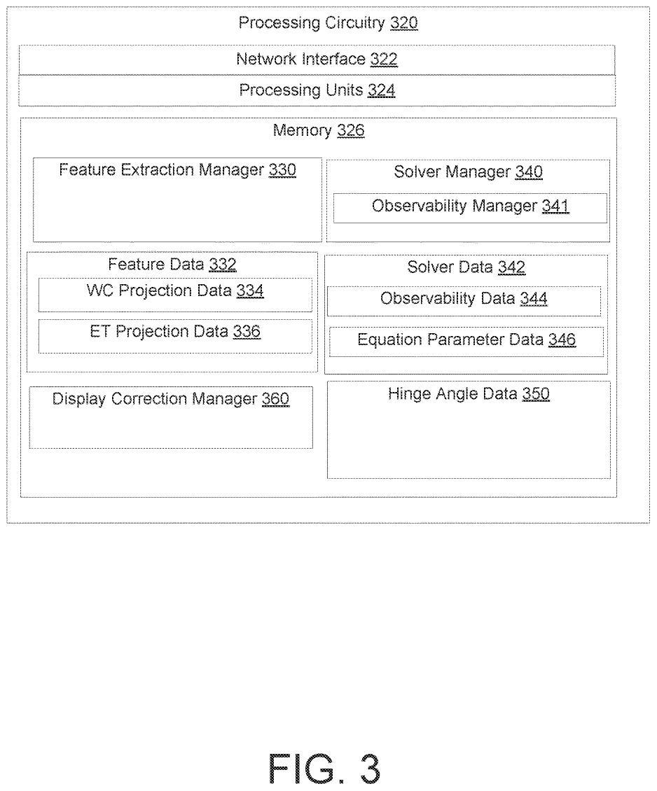

FIG. 3 is a diagram that illustrates an example of processing circuitry 320. The processing circuitry 320 includes a network interface 322, one or more processing units 324, and nontransitory memory 326. The network interface 322 includes, for example, Ethernet adaptors, Token Ring adaptors, and the like, for converting electronic and/or optical signals received from the network to electronic form for use by the processing circuitry 320. The set of processing units 324 include one or more processing chips and/or assemblies. The memory 326 includes both volatile memory (e.g., RAM) and non-volatile memory, such as one or more ROMs, disk drives, solid state drives, and the like. The set of processing units 324 and the memory 326 together form processing circuitry, which is configured and arranged to carry out various methods and functions as described herein.

In some implementations, one or more of the components of the processing circuitry 320 can be, or can include processors (e.g., processing units 324) configured to process instructions stored in the memory 326. Examples of such instructions as depicted in FIG. 3 include feature extraction manager 330, solver manager 340, and display correction manager 360. Further, as illustrated in FIG. 3, the memory 326 is configured to store various data, which is described with respect to the respective managers that use such data.

The feature extraction manager 330 is configured to obtain feature data 332 via a feature extraction process. For example, a feature extraction process includes illuminating an object in the vicinity of the world-facing camera and the eye-tracking camera and capturing images of the illuminated portion of the object in those cameras. The processing circuitry determines statistics for a set of small regions in each of the images and looks for a match between the images. The point p corresponds to a match and is accordingly the feature data 332.

As shown in FIG. 3, the feature data includes world camera projection data 334 and eye-tracking projection data 336. In some implementations, the world camera projection data 334 corresponds to 1p and the eye-tracking projection data 336 corresponds to ₂p. In some implementations, the world camera projection data 334 corresponds to ₁y and the eye-tracking projection data 336 corresponds to ₂y.

The solver manager 340 is configured to determine the hinge angle θ, e.g., hinge angle data 350. As shown in FIG. 3, the solver manager 340 includes an observability manager 341 that determines whether, given the feature data 332, the hinge angle θ is observable, i.e., whether there is a unique value of θ. As described above, the observability manager 341 determines whether the point p is coplanar with the plane defined by the world-facing camera, the eye-tracking camera, and the hinge center.

As shown in FIG. 3, the solver data 342 includes observability data 344 that indicates whether the hinge angle θ is observable or not. If the observability data 344 indicates that θ is not observable, then no hinge angle is found. If the observability manager 344 indicates that θ is observable, then solver manager 340 generates the equation parameter data 346 as specified parameters a, b, and c in Eq. (4) above.

In some implementations, the solver manager 340 determines whether Eq. (4) has two solutions, and if so, which solution is spurious.

Display correction manager 360 performs a display correction (e.g., a determination of a position of visual content output by the display) given the hinge angle θ in hinge angle data 350. If the hinge angle θ is determined to be unobservable, then the display correction manager 360 does not perform a correction.

The components (e.g., modules, processing units 324) of processing circuitry 320 can be configured to operate based on one or more platforms (e.g., one or more similar or different platforms) that can include one or more types of hardware, software, firmware, operating systems, runtime libraries, and/or so forth. In some implementations, the components of the processing circuitry 320 can be configured to operate within a cluster of devices (e.g., a server farm). In such an implementation, the functionality and processing of the components of the processing circuitry 320 can be distributed to several devices of the cluster of devices.

The components of the processing circuitry 320 can be, or can include, any type of hardware and/or software configured to process attributes. In some implementations, one or more portions of the components shown in the components of the processing circuitry 320 in FIG. 3 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 320 can be, or can include, a software module configured for execution by at least one processor (not shown). In some implementations, the functionality of the components can be included in different modules and/or different components than those shown in FIG. 3, including combining functionality illustrated as two components into a single component.

Although not shown, in some implementations, the components of the processing circuitry 320 (or portions thereof) can be configured to operate within, for example, a data center (e.g., a cloud computing environment), a computer system, one or more server/host devices, and/or so forth. In some implementations, the components of the processing circuitry 320 (or portions thereof) can be configured to operate within a network. Thus, the components of the processing circuitry 320 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, feature extraction manager 330 (and/or a portion thereof), solver manager 340 (and/or a portion thereof), and display correction manager 360 (and/or a portion thereof are examples of such instructions.

In some implementations, the memory 326 can be any type of memory such as a random-access memory, a disk drive memory, flash memory, and/or so forth. In some implementations, the memory 326 can be implemented as more than one memory component (e.g., more than one RAM component or disk drive memory) associated with the components of the processing circuitry 320. In some implementations, the memory 326 can be a database memory. In some implementations, the memory 326 can be, or can include, a non-local memory. For example, the memory 326 can be, or can include, a memory shared by multiple devices (not shown). In some implementations, the memory 326 can be associated with a server device (not shown) within a network and configured to serve the components of the processing circuitry 320.

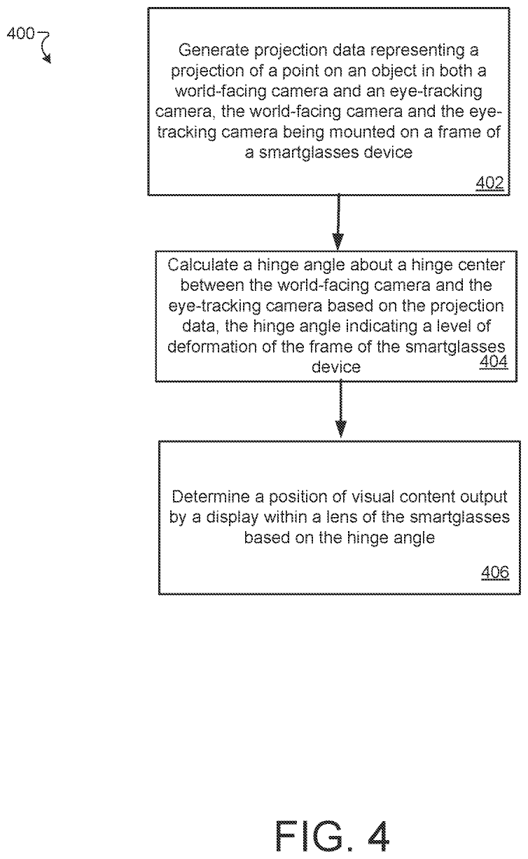

FIG. 4 is a flow chart depicting an example method 400 of performing a display correction. The method 400 may be performed by software constructs described in connection with FIG. 3, which reside in memory 326 of the processing circuitry 320 and are run by the set of processing units 324.

At 402, a feature extraction manager (e.g., feature extraction manager 330) receives projection data representing a projection of a point on an object in both a world-facing camera (e.g., world-facing camera 116) and an eye-tracking camera (e.g., eye-tracking camera 115), the world-facing camera and the eye-tracking camera being mounted on a frame (e.g., frame 110) of a smartglasses device (e.g., smartglasses device 100).

At 404, a solver manager (e.g., solver manager 340) generates a hinge angle about a hinge center between the world-facing camera and the eye-tracking camera based on the projection data, the hinge angle indicating a level of deformation of the frame of the smartglasses device.

At 406, the display correction manager (e.g., display correction manager 360) determines a position of visual content output by a display (e.g., visual content output by the display device 104) within a lens (e.g., lens 127) of the smartglasses device based on the hinge angle. In one example, the display correction manager may use a machine learning engine to determine the position of visual content display based on the hinge angle. In another example, the display correction manager may use a lookup table to determine the position of visual content display based on the hinge angle.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method, comprising:
generating projection data representing a projection of a point on an object in both a world-facing camera and an eye-tracking camera, the world-facing camera and the eye-tracking camera being mounted on a frame of a smartglasses device;
calculating a hinge angle about a hinge center between the world-facing camera and the eye-tracking camera based on the projection data, the hinge angle indicating a level of deformation of the frame of the smartglasses device; and
determining a position of visual content output by a display within a lens of the smartglasses device based on the hinge angle.

2. The method as in claim 1, wherein the projection data is generated via a feature extraction process in the world-facing camera and the eye-tracking camera.

3. The method as in claim 1, wherein generating the hinge angle includes:
determining whether the hinge angle is observable.

4. The method as in claim 3, wherein the hinge angle is observable if the point is noncoplanar with a plane defined by the world-facing camera, the eye-tracking camera, and the hinge center.

5. The method as in claim 3, wherein the hinge angle is not observable if the projection of the point in the world-facing camera is situated along a line of sight of the world-facing camera.

6. The method as in claim 1, wherein generating the hinge angle includes:
generating a solution to an equation, the equation being a+b cos θ+c sin θ=0, wherein θ is the hinge angle and a, b, and c are specified parameters.

7. The method as in claim 6, wherein solving the equation includes:
determining whether a spurious value of θ satisfies the equation.

8. A computer program product comprising a nontransitory storage medium, the computer program product including code that, when executed by processing circuitry, causes the processing circuitry to perform a method, the method comprising:
generating projection data representing a projection of a point on an object in both a world-facing camera and an eye-tracking camera, the world-facing camera and the eye-tracking camera being mounted on a frame of a smartglasses device;
calculating a hinge angle about a hinge center between the world-facing camera and the eye-tracking camera based on the projection data, the hinge angle indicating a level of deformation of the frame of the smartglasses device; and
determining a position of visual content output by a display within a lens of the smartglasses device based on the hinge angle.

9. The computer program product as in claim 8, wherein the projection data is generated via a feature extraction process in the world-facing camera and the eye-tracking camera.

10. The computer program product as in claim 8, wherein generating the hinge angle includes:
determining whether the hinge angle is observable.

11. The computer program product as in claim 10, wherein the hinge angle is observable if the point is noncoplanar with a plane defined by the world-facing camera, the eye-tracking camera, and the hinge center.

12. The computer program product as in claim 10, wherein the hinge angle is not observable if the projection of the point in the world-facing camera is situated along a line of sight of the world-facing camera.

13. The computer program product as in claim 8, wherein generating the hinge angle includes:
generating a solution to an equation, the equation being a+b cos θ+c sin θ=0, wherein θ is the hinge rotation and a, b, and c are specified parameters.

14. The computer program product as in claim 13, 13, wherein solving the equation includes:
determining whether a spurious value of θ satisfies the equation.

15. An apparatus, comprising:
memory; and
processing circuitry coupled to the memory, the processing circuitry being configured to:
generate projection data representing a projection of a point on an object in both a world-facing camera and an eye-tracking camera, the world-facing camera and the eye-tracking camera being mounted on a frame of a smartglasses device;
calculate a hinge angle about a hinge center between the world-facing camera and the eye-tracking camera based on the projection data, the hinge angle indicating a level of deformation of the frame of the smartglasses device; and
determine a position of visual content output by a display within a lens of the smartglasses device based on the hinge angle.

16. The apparatus as in claim 15, wherein the projection data is generated via a feature extraction process in the world-facing camera and the eye-tracking camera.

17. The apparatus as in claim 15, wherein the processing circuitry configured to generate the hinge angle is further configured to:
determine whether the hinge angle is observable.

18. The apparatus as in claim 17, wherein the hinge angle is observable if the point is noncoplanar with a plane defined by the world-facing camera, the eye-tracking camera, and the hinge center.

19. The apparatus as in claim 17, wherein the hinge angle is not observable if the projection of the point in the world-facing camera is situated along a line of sight of the world-facing camera.

20. The apparatus as in claim 15, wherein the processing circuitry configured to generate the hinge angle is further configured to:
generate a solution to an equation, the equation being a+b cos θ+c sin θ=0, wherein θ is the hinge rotation and a, b, and c are specified parameters.
